(19) United States
(12) Patent Application Publication
(10) Pub. No.: US 2021/0089369 A1
(43) Pub. Date: Mar. 25, 2021

(54) Conditional Device Application Activation Responsive To A Notification Trigger

(71) Applicant: Motorola Mobility LLC, Chicago, IL (US)

(72) Inventors: Alexandre Neves Creto, Sao Paulo (BR); Rodrigo Borrozino, Campinas (BR); Kenneth J. Crisler, Lake Zurich, IL (US)

(73) Assignee: Motorola Mobility LLC, Chicago, IL (US)

(21) Appl. No.: 16/578,001

(22) Filed: Sep. 20, 2019

(51) Int. Cl. G06F 9/54; G06F 3/14; G06F 1/16

(52) U.S. Cl. CPC G06F 9/542; G06F 1/1647; G06F 3/1431

(57) ABSTRACT

In aspects of conditional device application activation responsive to a notification trigger, a dual-screen device has a secondary screen to display a notification associated with a device application, and has a primary screen to display a user interface of the device application responsive to activation of the notification. The dual-screen device implements a notification control module to receive a trigger input of the notification to activate the device application, and determine one or more conditions that facilitate activation of the device application in a current configuration of the dual-screen device. The notification control module can then maintain the notification for subsequent display if the one or more conditions are not conducive to facilitate the activation of the device application responsive to the trigger input of the notification.

### BACKGROUND

Devices such as smart devices, mobile devices (e.g., cellular phones, tablet devices), consumer electronics, and the like can be implemented for use in a wide range of industries and for a variety of different applications. Many of these devices can have multiple device configurations, such as dual-screen devices that have primary and secondary display screens, foldable devices that have a foldable display screen, flip phones that a user can flip between a closed configuration and an open configuration, and other mobile device configurations. Generally, a foldable device, a flip phone, and even some smartphones or tablet devices that do not fold or flip may also have more than one display screen and can be implemented as a dual-screen device.

These dual-screen devices are generally designed with a secondary display screen that is relatively smaller than the primary display screen of the device, and the secondary display screen may be utilized primarily as a notification screen that displays an indication of a new text message, an indication of a new email message that has been received, or an indication of an incoming phone call. A user of a device that has received a notification can then select or activate the notification to initiate displaying the new text message, the new email message, or the phone interface to accept the incoming call on the primary display screen of the device. Generally, user interactions and application display features are limited on the secondary display screen of many devices, yet device interactions associated with the notifications that are initiated on the secondary display screen can be continued on the primary display screen of a device.

In some instances, a user of a dual-screen device may not want to immediately select a notification when it is received to display content associated with the notification on the primary display screen of a device. If the user selects a notification on the secondary display, but the primary display is not readily accessible or in an active state, such as if a flip phone is closed for example, the notification will be consumed and dismissed, and is no longer available for display on the secondary display. In other instances, a notification that is received and displayed on the notification screen of a device may be inadvertently triggered, such as by an accidental touch input on the secondary screen. The notification is then consumed and dismissed, and is no longer displayed for the user, regardless of whether the user intended to trigger the notification or not. The user then loses the information and context that was provided by the notification.

Similarly, a smartwatch may be used as a companion device that is paired with a mobile phone of a user. The smartwatch has a smaller notification screen that can display a notification for an application or program on the paired mobile phone. Generally, the notification screen on the smartwatch may be utilized primarily to display notifications, such as an indication of a new text message, an indication of a new email message that has been received, or an indication of an incoming phone call. A user of a smartwatch or other companion device that has received a notification can then select or activate the notification to initiate displaying the new text message, the new email message, or the phone interface to accept the incoming call on the paired mobile phone. However, if the user selects a notification on the smartwatch, but the mobile phone is not readily accessible or in an active state, the notification will be consumed and dismissed, and is no longer available for display on the companion device.

### BRIEF DESCRIPTION OF THE DRAWINGS

Implementations of the techniques of conditional device application activation responsive to a notification trigger are described with reference to the following Figures. The same numbers may be used throughout to reference like features and components shown in the Figures:

FIG. 1 illustrates an example device that can be used to implement techniques of conditional device application activation responsive to a notification trigger as described herein.

FIG. 2 illustrates an example of a multi-screen system in which aspects of conditional device application activation responsive to a notification trigger can be implemented.

FIG. 3 illustrates an example method of conditional device application activation responsive to a notification trigger as implemented in a foldable device in accordance with one or more implementations of the techniques described herein.

FIG. 4 illustrates an example method of conditional device application activation responsive to a notification trigger as implemented by a dual-screen device in accordance with one or more implementations of the techniques described herein.

FIG. 5 illustrates an example method of conditional device application activation responsive to a notification trigger as implemented in a multi-screen system in accordance with one or more implementations of the techniques described herein.

FIG. 6 illustrates various components of an example device that can used to implement the techniques of conditional device application activation responsive to a notification trigger as described herein.

### DETAILED DESCRIPTION

Implementations of conditional device application activation responsive to a notification trigger are described, and provide techniques to maintain a notification that has been intentionally or accidentally triggered if a device configuration or application operating condition is not conducive to activating the device application that is associated with the notification. For example, a notification that indicates having received a text message or a new email message, or a notification of an incoming phone call, may be received and displayed on a notification screen of a dual-screen device. A user of the device may then select the notification, such as with a touch input or some other type of trigger input to activate a device application that is associated with the notification to then display the text message, the new email message, or the phone interface to accept the incoming call.

However, with a foldable device or a flip phone in a closed configuration, a user interface of a text application or an email application would not be displayed on the primary display screen that is folded and concealed from view inside of the device. An operating condition needed to activate a device application responsive to the notification being triggered has not been met with the foldable device or flip phone in the closed configuration and the primary display screen being concealed from view. Rather than the notification then being consumed or dismissed and no longer displayed for user viewing and selection, the notification is maintained for subsequent display and the device reverts to the previous notification state of the device. This provides the user of the device with another opportunity to select and trigger the notification.

In another example, a multi-screen system can include a companion device, such as a smartwatch, that is paired with a mobile phone and/or other types of mobile devices. The smartwatch has a smaller notification screen that can display a notification for an application or program that executes and displays on the paired mobile phone. Generally, the notification screen on the smartwatch may be utilized primarily to display notifications, such as an indication of a new text message having been received, or an indication of an incoming phone call. A user of the companion device that has received a notification can then select or activate the notification to initiate displaying the new text message or the phone interface to accept the incoming call on the paired mobile phone. However, the paired mobile phone may not be in an active state or readily accessible to the user, and rather than the notification being consumed or dismissed and the user losing the information and context that was provided by the notification, the notification is maintained for subsequent display and the companion device reverts to the previous notification state of the device.

In aspects of conditional device application activation responsive to a notification trigger as described herein, a mobile device implements a notification control module that is designed to monitor and control when notifications are consumed or dismissed, and when the notifications are maintained or persisted. The notification control module can receive or interrupt a notification that comes into the mobile device, and also receive or determine a trigger input of the notification to activate a device application that is associated with the notification. The trigger input of a notification can be received by the notification control module as an interaction trigger, such as a user selection or input of the notification to activate the associated device application and display viewable content associated with the notification. As described above, a user of the device may select the notification, such as with a touch input or some other type of trigger input to activate the device application that is associated with the notification. In the case of a foldable device or a flip phone, a user of the device may initiate the trigger input as a flip-open gesture of the device.

The notification control module is also implemented to determine application conditions that would facilitate activation of a device application in a current configuration of the mobile device. The notification control module can receive one or more application conditions as operating requirements to facilitate activation of the device application from the device application itself. The application conditions can include any device configuration and/or operating condition needed to activate and run a device application that is associated with a notification, such as display screen size, available bandwidth, having a network connection, and/or any other device configuration or application operating condition to activate and run a device application on the device.

Notably, the notification control module implemented by the mobile device can determine that an application condition needed to activate a device application responsive to a notification being triggered has not been met, such as a foldable device being in a closed configuration, or a smartphone lacking network connectivity. To avoid the notification then being consumed or dismissed and no longer displayed for user viewing and selection, the notification control module is implemented to maintain the notification for subsequent display if one or more of the application conditions are not conducive to facilitate the activation of the device application responsive to a trigger input of the notification.

While features and concepts of conditional device application activation responsive to a notification trigger modification can be implemented in any number of different devices, systems, environments, and/or configurations, implementations of conditional device application activation responsive to a notification trigger are described in the context of the following example devices, systems, and methods.

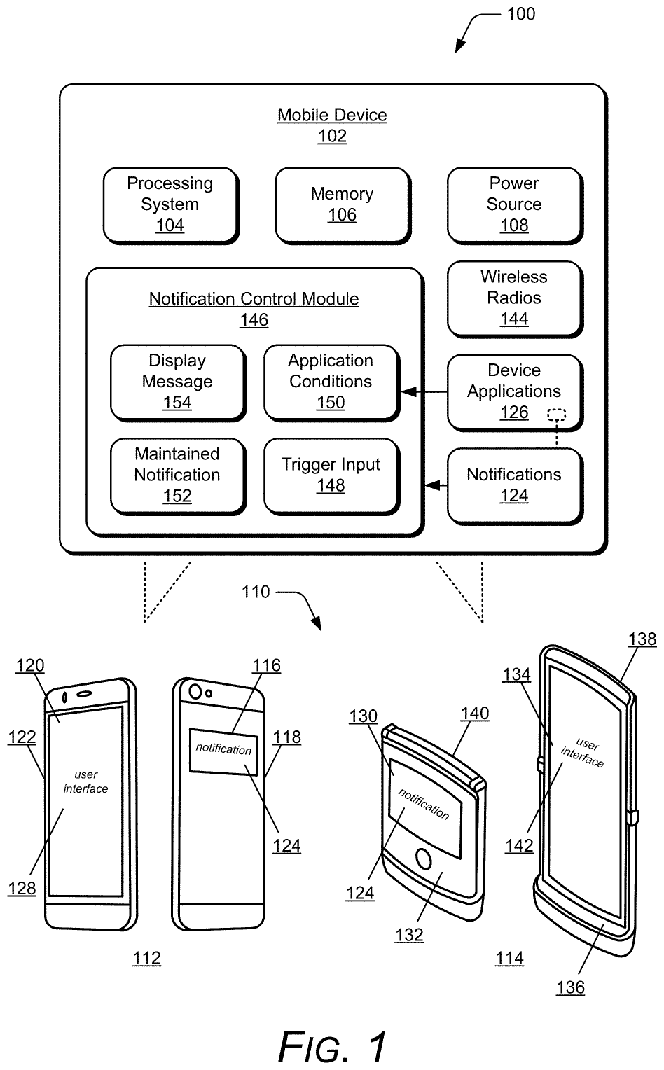

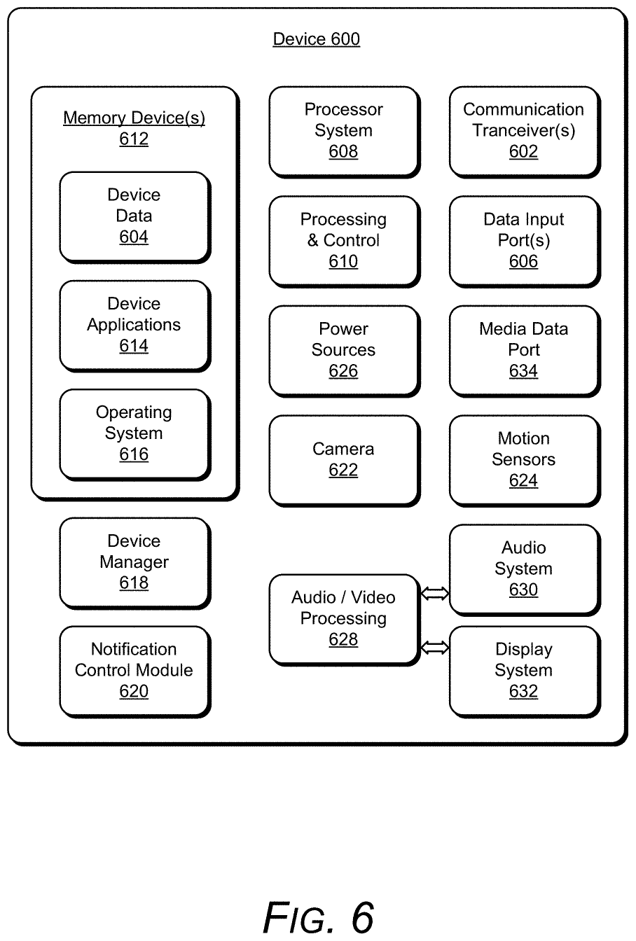

FIG. 1 illustrates an example 100 of a mobile device 102 that can be used to implement techniques of conditional device application activation responsive to a notification trigger, as described herein. In this example 100, the mobile device 102 may be any type of a computing device, tablet device, mobile phone, flip phone, smart watch, a companion device that may be paired with other mobile devices, and/or any other type of mobile device. Generally, the mobile device 102 may be any type of an electronic and/or computing device implemented with various components, such as a processing system 104 and memory 106, as well as any number and combination of different components as further described with reference to the example device shown in FIG. 6. For example, the mobile device 102 can include a power source 108 to power the device, such as a rechargeable battery and/or any other type of active or passive power source that may be implemented in an electronic and/or computing device.

In implementations, the mobile device 102 may be any type of a dual-screen device 110, such as a tablet device, a mobile phone 112, or a foldable device 114 (e.g., a flip phone) that has at least two display screens. For example, the mobile phone 112 (also commonly referred to as a “smartphone” that does not fold or flip) has a secondary screen 116 on one side 118 (e.g., the back) of the device and a primary screen 120 on another side 122 (e.g., the front) of the device. Generally, the secondary screen 116 and the primary screen 120 on the opposite sides of the mobile phone 112 may be the same size, approximately the same size, or vary in different sizes. In this example, the secondary screen 116 is relatively smaller than the primary screen 120 and may be utilized primarily as a notification screen that displays notifications 124, such as text messages associated with a text application on the device, email messages associated with an email application on the device, a video service notification associated with a video display application on the device, and/or any other type of notifications associated with device applications 126 that execute on the mobile phone.

Additionally, the primary screen 120 in this example of the mobile phone 112 is relatively larger than the secondary screen 116 and may be utilized to display a user interface 128 of any of the device applications 126, such as to display text messages, email messages, video media, and/or any other type of viewable content and media associated with the device applications. Generally, a user of the mobile phone 112 may receive a notification 124 that displays for viewing on the secondary screen 116 of the device, such as a notification of having received a text message or a new email message, or a notification of a new video as suggested viewing for the user of the device. The user may then select the notification 124, such as with a touch input on the secondary screen 116 or some other type of trigger input to activate a device application 126 that is associated with the notification. A corresponding user interface 128 of the activated device application 126 that is associated with the notification 124 can then display the text message, the new email message, the video media, or any other type of viewable content associated with the notification having been triggered by user interaction.

In another example, the foldable device 114 is shown as a flip phone that also has two display screens. It should be noted that conventional flip phones are not generally thought of as having the multitude of features generally associated with smartphones, having mainly just cellular call functionality and a camera. However, newer style flip phones or foldable devices may also implement many smartphone features, and with the advent of foldable displays, such as bendable OLED displays, a foldable device may be any type of flip-smartphone, or a smart flip phone. The foldable device 114 has a secondary screen 130 on an outside 132 of the device and a primary screen 134 on an inside 136 of the device. Generally, the secondary screen 130 and the primary screen 134 are viewable on opposite sides of the foldable device 114 in an open configuration 138 of the device, similar to the two display screens 116, 120 of the mobile phone 112. However, in a closed configuration 140 of the device, the secondary screen 130 remains viewable while the primary screen 134 is folded and concealed from view inside of the device.

In this example of the foldable device 114, the secondary screen 130 is relatively smaller than the primary screen 134 and may be utilized mainly as a notification screen that displays notifications 124 when the device is in the closed configuration 140, such as an indication of an incoming phone call, indications of text messages associated with a text application on the device, and/or any other type of notifications associated with device applications 126 that execute on the foldable device. Additionally, the primary screen 134 in this example of the foldable device 114 is relatively larger than the secondary screen 130 and may be utilized to display a user interface 142 of any of the device applications 126, such as to display text messages, email messages, video media, and/or any other type of viewable content and media associated with the device applications.

Generally, a user of the foldable device 114 may receive a notification 124 that displays for viewing on the secondary screen 130, such as a notification of an incoming phone call, a notification of having received a text message or a new email message, or a notification of a new video as suggested viewing for the user of the device. The user may then select the notification 124, such as with a touch input on the secondary screen 130 or some other type of trigger input to activate a device application 126 that is associated with the notification. For example, the user of the device may initiate the trigger input to activate the device application as a flip-open gesture of the foldable device 114 from the closed configuration 140 to the open configuration 138 of the device. A corresponding user interface 142 of the activated device application 126 that is associated with the notification 124 can then display the incoming phone call, the text message, the new email message, the video media, or any other type of viewable content associated with the notification having been triggered by user interaction.

In implementations, the mobile device 102 can communicate with other devices via a network (e.g., LTE, WLAN, etc.) or via a direct peer-to-peer connection (e.g., Wi-Fi Direct, Bluetooth™, Bluetooth LE (BLE), RFID, NFC, etc.). The mobile device 102 can include wireless radios 144 that facilitate wireless communications, as well as communication interfaces that facilitate network communications. The mobile device 102 can be implemented for data communication between devices and network systems, which may include wired and/or wireless networks implemented using any type of network topology and/or communication protocol, to include IP based networks, and/or the Internet, as well as networks that are managed by mobile network operators, such as a communication service providers, mobile phone providers, and/or Internet service providers.

As noted above, a mobile device, such as the mobile phone 112 or the foldable device 114, may receive a notification 124 that is associated with a device application 126, and the notification is displayed on a notification screen of the device. In some instances, a user of the device may not want to immediately trigger the notification 124 when it is received to initiate the user interface of the associated device application 126 displaying on the typically larger display screen of the device. In other instances, a notification 124 that is received and displayed on the notification screen of a device may be inadvertently triggered, such as by an accidental touch input to the notification on the notification screen.

For example, a user may inadvertently contact or trigger a notification 124 that is displayed on the secondary screen 116 on the back of the mobile phone 112 without intending to activate the device application 126 that is associated with the notification. Similarly, a user may inadvertently contact or trigger a notification 124 that is displayed on the secondary screen 130 on the outside of the foldable device 114 while the device is in the closed configuration 140. However, with the foldable device 114 in the closed configuration 140, the device application 126 that is associated with the notification 124 cannot be activated to display the corresponding user interface on the primary screen 134 that is folded and concealed from view inside of the device. An operating condition needed to activate the device application 126 responsive to the notification 124 being triggered has not been met (i.e., the foldable device 114 is in the closed configuration 140). The notification 124 may then be consumed or dismissed and no longer displayed for the user, regardless of whether the user intended to trigger the notification or not, and regardless of whether the device application 126 could be activated to display the viewable content associated with the notification. The user then loses the information and context that was provided by the notification.

In this example 100, the mobile device 102 includes a notification control module 146 that implements features of conditional device application activation responsive to a notification trigger, as described herein. The notification control module 146 may be implemented as a module that includes independent processing, memory, and logic components functioning as a computing and/or electronic device integrated with the mobile device 102. Alternatively or in addition, the notification control module 146 can be implemented as a software application or software module, such as with the operating system and as computer-executable software instructions that are executable with a processor (e.g., with the processing system 104) of the mobile device 102. As a software application or module, the notification control module 146 can be stored on computer-readable storage memory (e.g., the memory 106 of the device), or any other suitable memory device or electronic data storage implemented with the notification control module.

The notification control module 146 is implemented to monitor and control when the notifications 124 are consumed or dismissed, and when the notifications 124 are maintained or persisted. In implementations, the notification control module 146 is implemented to receive or interrupt a notification 124 that comes into the mobile device 102, such as a notification of a text message associated with a text application on the device, a notification of a new email message associated with an email application on the device, a notification of an incoming phone call, a video service notification associated with a video display application on the device, and/or any other type of notifications 124 associated with the device applications 126 that execute on the mobile device.

The notification control module 146 can also receive, determine, or interrupt a trigger input 148 of a notification 124 to activate the device application 126 that is associated with the notification. The trigger input 148 of a notification 124 can be received by the notification control module 146 as an interaction trigger, such as a user selection or input of the notification to activate the associated device application 126 and display the viewable content associated with the notification. As described above, a user of the device may select the notification 124, such as with a touch input or some other type of trigger input to activate the device application 126 that is associated with the notification. In the case of the foldable device 114, a user of the device may initiate the trigger input as a flip-open gesture of the foldable device from the closed configuration 140 to the open configuration 138 of the device.

The notification control module 146 is also implemented to determine the application conditions 150 that would facilitate activation of the device application 126 in a current configuration of the mobile device 102. In implementations, the notification control module 146 can receive one or more of the application conditions 150 as operating requirements to facilitate activation of the device application 126 from the device application itself. The application conditions 150 can include any device configuration and/or operating condition needed to activate and run a device application 126 that is associated with a notification, such as if the device application has an audio requirement, a video output and display screen size requirement, available bandwidth, a network connection for downloading and/or streaming data, and/or any other device configuration and/or operating condition to activate and run a device application on the device.

For example, a device application 126 on the foldable device 114 may not be able to activate and run responsive to a trigger input 148 of a notification 124 if the foldable device is in the closed configuration 140, given that the user interface of the device application 126 cannot be displayed on the primary screen 134 that is folded and concealed from view inside of the device. Notably, the notification control module 146 can determine that an application condition 150 needed to activate the device application 126 responsive to the notification 124 being triggered has not been met (i.e., the foldable device 114 is in the closed configuration 138). To avoid the notification 124 then being consumed or dismissed and no longer displayed for user viewing and selection, the notification control module 146 is implemented to maintain the notification (e.g., maintained notification 152) for subsequent display if one or more of the application conditions 150 are not conducive to facilitate the activation of the device application 126 responsive to the trigger input 148 of the notification.

In another example, the mobile phone 112 is a smartphone that includes an email application as one of the device applications 126, and a notification 124 may be received and displayed on one or either of the secondary screen 116 or the primary screen 120 of the device. However, if the mobile phone 112 then does not have a network connection when the user selects the notification 124 as a trigger input 148, the email application would not be able to download the new email content for display. Notably, the notification control module 146 can determine that an application condition 150 needed to activate the device application 126 (e.g., the email application) responsive to the notification 124 being triggered has not been met (i.e., the mobile phone 112 does not have network connectivity). To avoid the notification 124 then being consumed or dismissed and no longer displayed for user viewing and selection, the notification control module 146 is implemented to maintain the notification (e.g., the maintained notification 152) for subsequent display if one or more of the application conditions 150 are not conducive to facilitate the activation of the device application 126 responsive to the trigger input 148 of the notification.

Additionally, the notification control module 146 can be implemented to monitor the application conditions 150 for a particular device application 126 over a time duration to determine whether the application conditions change to facilitate the activation of the device application responsive to a trigger input 148 of the notification 124 that is associated with the device application. If one or more of the application conditions 150 are still not met to facilitate the activation of the device application 126 after the designated time duration, the notification control module 146 can then maintain the notification 152 for subsequent display, thus reverting to the previous notification state of the device. Alternatively, if the application conditions 150 are determined to facilitate the activation of the device application 126 after the time duration, then the notification control module 146 can dismiss the notification 124 as having been triggered and utilized by the user of the device, such as to initiate display of a user interface of the device application 126 and display the viewable content associated with the notification.

In an event that application conditions 150 are not met to facilitate the activation of a device application 126, the notification control module 146 is implemented to generate a display message 154 to indicate that one or more of the application conditions have not been met, and are not conducive to facilitate the activation of the device application. For example, the display message 154 can be displayed for viewing on one or either of the secondary screen 116 or the primary screen 120 of the mobile phone 112. Similarly, the display message 154 can be displayed for viewing on one or either of the secondary screen 130 or the primary screen 134 of the foldable device 114. Notably, a user of the foldable device 114 is more likely to see the display message 154 displayed on the secondary screen 130 that is viewable in the closed configuration 140 of the device, or likely to see the display message 154 displayed on the primary screen 134 that is viewable in the open configuration 138 of the device.

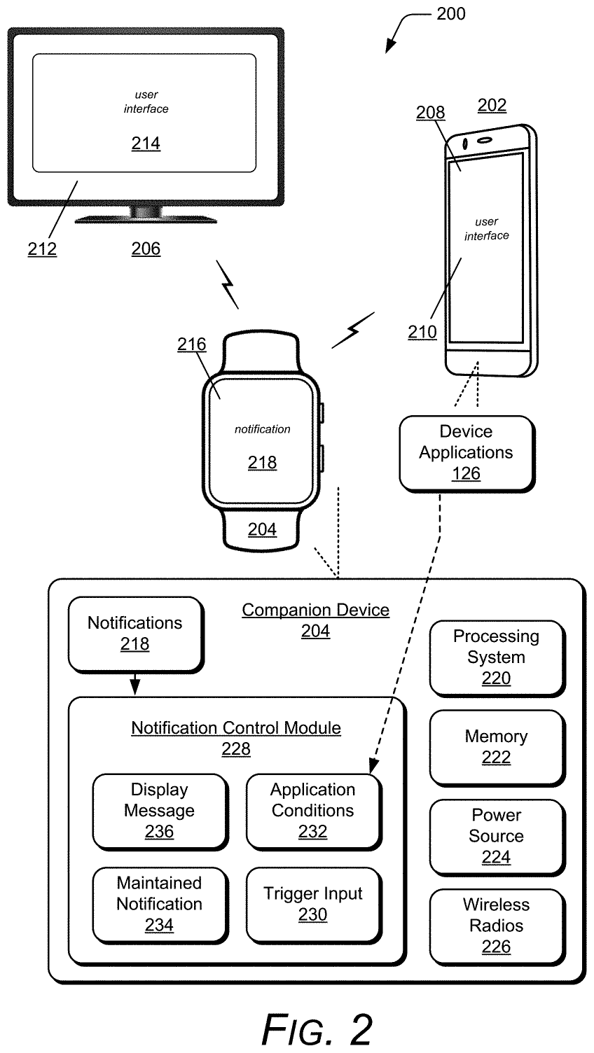

FIG. 2 illustrates an example of a multi-screen system 200 in which aspects of conditional device application activation responsive to a notification trigger can be implemented, as described herein. This example multi-screen system 200 can include two or several devices, such as a mobile phone 202, a companion device 204 (e.g., a smart watch), and a display device 206, which may be any type of a display-capable device, such as a computing device, tablet device, television, video media playback device, and the like. Generally, any one or more of the mobile phone 202, the companion device 204, and the display device 206 can be implemented as the mobile device 102 that is shown and described with reference to FIG. 1, and may include any number and combination of different components as further described with reference to the example device shown in FIG. 6.

In this example, the mobile phone 202 has a display screen 208 to display a user interface 210 of a device application 126, such as an email application user interface, a text application user interface, a phone application user interface, or any other type of device application user interface. Similarly, the display device 206 has a device screen 212 to display a user interface 214 of a device application 126, such as a video playback application to display video media for viewing. The companion device 204 can be paired with the mobile phone 202 and/or with the display device 206. The companion device has a notification screen 216 to display a notification 218 that is associated with a device application 126, which executes on any of the other devices in the multi-screen system 200, such as the mobile phone 202 and/or the display device 206.

Similar to the mobile device 102 that is shown and described with reference to FIG. 1, the companion device 204 includes various components, such as a processing system 220 and memory 222, as well as any number and combination of different components as further described with reference to the example device shown in FIG. 6. For example, the companion device 204 can include a power source 224 to power the device, such as a rechargeable battery and/or any other type of active or passive power source that may be implemented in an electronic and/or computing device.

Generally, a user of the companion device 204 may receive a notification 218 that displays for viewing on the notification screen 216, such as a notification of an incoming phone call, a notification of having received a text message or a new email message, or a notification of a new video as suggested viewing for the user of the device. The user may then select the notification 218, such as with a touch input on the notification screen 216 or some other type of trigger input to activate a device application that is associated with the notification on another one of the devices in the multi-screen system 200. For example, the user of the companion device 204 may select a notification 218 for an incoming phone call to activate the mobile phone 202 and a device phone application to facilitate answering the phone call on the mobile phone. A corresponding user interface 210 of the activated device phone application that is associated with the notification 218 can then display the incoming phone call on the display screen 208 of the mobile phone, or any other type of viewable content associated with the notification 218 having been triggered by user interaction on the companion device 204.

In implementations, the companion device 204 can communicate with other devices via a network (e.g., LTE, WLAN, etc.) or via a direct peer-to-peer connection (e.g., Wi-Fi Direct, Bluetooth™, Bluetooth LE (BLE), RFID, NFC, etc.). The companion device 204 can include wireless radios 226 that facilitate wireless communications, as well as communication interfaces that facilitate network communications. The companion device 204 can be implemented for data communication between devices and network systems, which may include wired and/or wireless networks implemented using any type of network topology and/or communication protocol, to include IP based networks, and/or the Internet, as well as networks that are managed by mobile network operators, such as a communication service providers, mobile phone providers, and/or Internet service providers.

In this example multi-screen system 200, the companion device 204 includes a notification control module 228 that implements features of conditional device application activation responsive to a notification trigger, as similarly described with reference to the notification control module 146 shown and described with reference to FIG. 1. The notification control module 228 may be implemented as a module that includes independent processing, memory, and logic components functioning as a computing and/or electronic device integrated with the companion device 204. Alternatively or in addition, the notification control module 228 can be implemented as a software application or software module, such as with the operating system and as computer-executable software instructions that are executable with a processor (e.g., with the processing system 220) of the companion device 204. As a software application or module, the notification control module 228 can be stored on computer-readable storage memory (e.g., the memory 222 of the device), or any other suitable memory device or electronic data storage implemented with the notification control module.

The notification control module 228 is implemented to monitor and control when the notifications 218 are consumed or dismissed, and when the notifications 218 are maintained or persisted. In implementations, the notification control module 228 is implemented to receive or interrupt a notification 218 that comes into the companion device 204, such as a notification of a text message associated with a text application on a paired device, a notification of a new email message associated with an email application on a paired device, a notification of an incoming phone call on a paired device, a video service notification associated with a video display application on a paired device, and/or any other type of notifications 124 associated with device applications 126 that execute on another device in the multi-screen system 200 that is paired with the companion device.

The notification control module 228 can also receive, determine, or interrupt a trigger input 230 of a notification 218 to activate a device application 126 that is associated with the notification and executable on a paired device, such as on the mobile phone 202 and/or on the display device 206. The trigger input 230 of a notification 218 can be received by the notification control module 228 as an interaction trigger, such as a user selection or input of the notification to activate the device application on the paired device and display the viewable content associated with the notification. As described above, a user of the companion device 204 may select the notification 218, such as with a touch input or some other type of trigger input to activate a device application on a paired device that is associated with the notification.

The notification control module 228 is also implemented to determine the application conditions 232 that would facilitate activation of the device application 126 on a paired device. In an environment such as the multi-screen system 200, in which the companion device 204 is paired with more than one of the other devices in the system, the notification control module 228 can utilize the application conditions 232 to determine which of the paired devices may be best suited to display the viewable content associated with a notification 218 that is received at the companion device. For example, the companion device 204 may receive a video service notification associated with a video display application, and the notification 218 may be selected to activate the playback of a video for viewing on either of the paired devices (e.g., on the mobile phone 202 or on the display device 206). The notification control module 228 can utilize the application conditions 232 to determine that the video may be best presented on the display device 206, and the device application on the display device is initiated to display the video for viewing.

In implementations, the notification control module 228 can receive one or more of the application conditions 232 as operating requirements to facilitate activation of the device application 126 from the device application itself. The application conditions 232 can include any device configuration and/or operating condition needed to activate and run a device application that is associated with a notification 218, such as if the device application has an audio requirement, a video output and display screen size requirement, available bandwidth, a network connection for downloading and/or streaming data, and/or any other device configuration and/or operating condition to activate and run a device application on one of the paired devices.

For example, the mobile phone 202 may lack network connectivity when the user selects the notification 218 as a trigger input 230 on the companion device 204, and the associated device application 126 may not be able to download application data associated with the notification. Notably, the notification control module 228 can determine that an application condition 232 needed to activate the device application 126 responsive to the notification 218 being triggered has not been met (i.e., the mobile phone 202 does not have a network connection). To avoid the notification 218 then being consumed or dismissed and no longer displayed for user viewing and selection on the companion device 204, the notification control module 228 is implemented to maintain the notification (e.g., maintained notification 234) as a persisted notification for subsequent display if one or more of the application conditions 232 are not conducive to facilitate the activation of the device application 126 responsive to the trigger input 230 of the notification.

Additionally, the notification control module 228 can be implemented to monitor the application conditions 232 for a particular device application 126 over a time duration to determine whether the application conditions change to facilitate the activation of the device application on the paired device responsive to a trigger input 230 of the notification 218 that is associated with the device application. If one or more of the application conditions 232 are still not met to facilitate the activation of the device application 126 after the designated time duration, the notification control module 228 can then maintain the notification 234 for subsequent display, thus reverting to the previous notification state of the companion device. Alternatively, if the application conditions 232 are determined to facilitate the activation of the device application 126 on the paired device after the time duration, then the notification control module 228 can dismiss the notification 218 as having been triggered and utilized by the user of the device, such as to initiate display of a user interface 210 of the device application 126 and display the viewable content associated with the notification.

In an event that application conditions 232 are not met to facilitate the activation of a device application 126 on a paired device to the companion device 204, the notification control module 228 is implemented to generate a display message 236 to indicate that one or more of the application conditions have not been met, and are not conducive to facilitate the activation of the device application on the paired device (e.g., the mobile phone 202). For example, the display message 236 can be displayed for viewing on the notification screen 216 of the companion device 204. Alternatively or in addition, the display message 236 may be displayed for viewing on the display screen 208 of the mobile phone 202, or on any of the other devices in the multi-screen system 200.

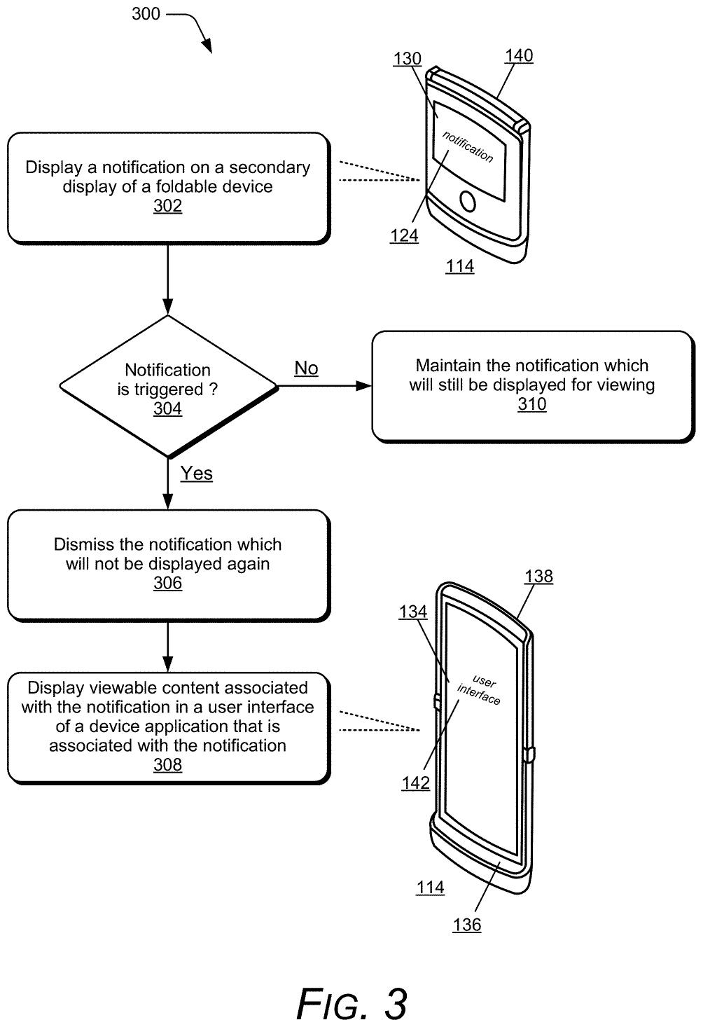

Example methods 300, 400, and 500 are described with reference to respective FIGS. 3-5 in accordance with implementations of conditional device application activation responsive to a notification trigger. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 3 illustrates example method(s) 300 of conditional device application activation responsive to a notification trigger, and is generally described with reference to a notification control module implemented by a foldable device. The order in which the method is described is not intended to be construed as a limitation, and any number or combination of the described method operations can be performed in any order to perform a method, or an alternate method.

At 302, a notification is displayed on a secondary display of a foldable device. For example, the foldable device 114 as shown and described with reference to FIG. 1 has the secondary screen 130, which is generally used as a notification screen that displays notifications 124 when the device is in the closed configuration 140. A notification 124 may be received as an indication of an incoming phone call, an indication of a text message associated with a text application on the device, and/or any other type of notification associated with device applications 126 that execute on the foldable device.

At 304, a determination is made as to whether the notification is triggered. For example, the notification control module 146 that is implemented by the foldable device 114 determines whether a trigger input 148 of the notification 124 is received to activate the device application 126 that is associated with the notification. The trigger input 148 of the notification 124 can be received by the notification control module 146 as an interaction trigger, such as a user selection or input of the notification to activate the associated device application 126 and display the viewable content associated with the notification. A user of the device may select the notification 124, such as with a touch input, or for the foldable device 114, the user may initiate the trigger input as a flip-open gesture from the closed configuration 140 to the open configuration 138 of the device.

If the notification is triggered (i.e., “Yes” from 304), then at 306, the notification will be dismissed and will not be displayed again. For example, the notification control module 146 dismisses the notification 124 if a user of the foldable device 114 selects the notification 124 or flips open the device from the closed configuration 140 to the open configuration 138, activating the device application 126 that is associated with the notification.

At 308, viewable content associated with the notification is displayed in a user interface of a device application that is associated with the notification. For example, the corresponding user interface 142 of the activated device application 126 that is associated with the notification 124 displays on the primary screen 134 of the foldable device 114. The user interface 142 displays an incoming phone call, a text message, a new email message, video media, or any other type of viewable content associated with the notification 124 having been triggered by user interaction.

If the notification is not triggered (i.e., “No” from 304), then at 310, the notification is maintained and will still be displayed for viewing, or can subsequently be displayed for viewing. For example, the notification control module 146 detects that the foldable device 114 has been flipped open, however without the notification having been triggered. To avoid the notification 124 being consumed or dismissed and no longer displayed for user viewing and selection, the notification control module 146 maintains the notification (e.g., the maintained notification 152) for subsequent display and user interaction.

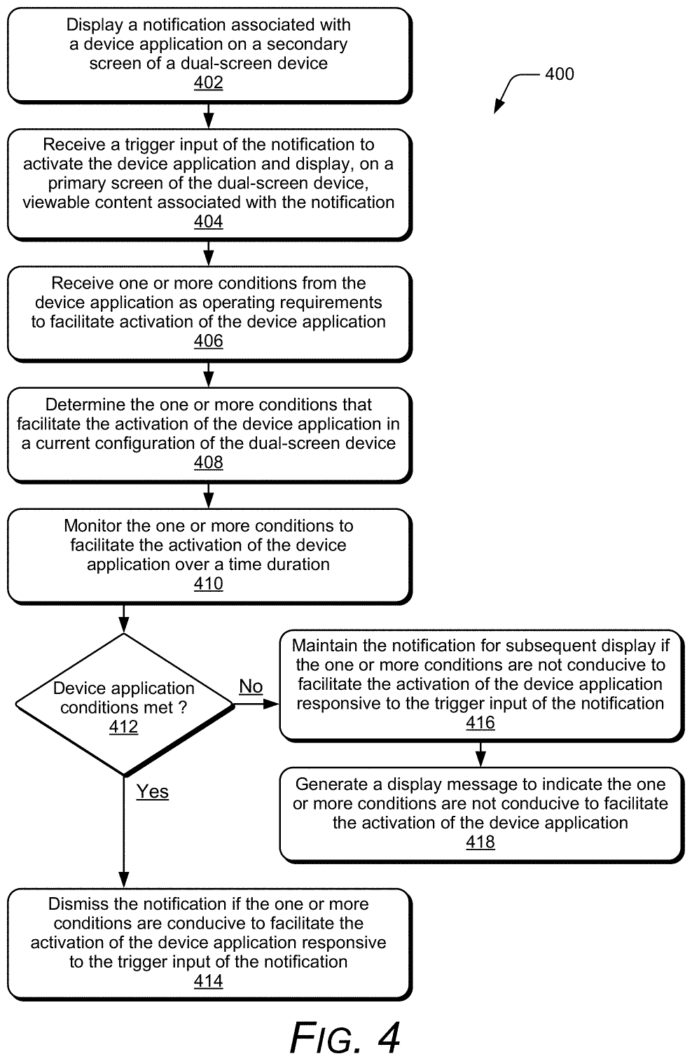

FIG. 4 illustrates example method(s) 400 of conditional device application activation responsive to a notification trigger, and is generally described with reference to a notification control module implemented by a dual-screen device. The order in which the method is described is not intended to be construed as a limitation, and any number or combination of the described method operations can be performed in any order to perform a method, or an alternate method.

At 402, a notification associated with a device application is displayed on a secondary screen of a dual-screen device. For example, the mobile phone 112 as shown and described with reference to FIG. 1 is a dual-screen device implemented as a smartphone that does not fold or flip, and has the secondary screen 116 on one side 118 (e.g., the back) of the device and the primary screen 120 on another side 122 (e.g., the front) of the device. The secondary screen 116 is utilized mainly as a notification screen that displays notifications 124, such as text messages associated with a text application on the device, email messages associated with an email application on the device, a video service notification associated with a video display application on the device, and/or any other type of notifications associated with device applications 126 that execute on the mobile phone.

Similarly, the foldable device 114 is a dual-screen device implemented as a flip phone that has the secondary screen 130 on an outside 132 of the device and the primary screen 134 on an inside 136 of the device. In the closed configuration 140 of the device, the secondary screen 130 remains viewable while the primary screen 134 is folded and concealed from view inside of the device. The secondary screen 130 is utilized mainly as a notification screen that displays notifications 124 when the device is in the closed configuration 140, such as an indication of an incoming phone call, indications of text messages associated with a text application on the device, and/or any other type of notifications associated with device applications 126 that execute on the foldable device.

At 404, a trigger input of the notification is received to activate the device application and display, on a primary screen of the dual-screen device, viewable content associated with the notification. For example, the notification control module 146 that is implemented by the mobile device 102 receives a trigger input 148 of a notification 124 to activate the device application 126 that is associated with the notification. The trigger input 148 of a notification 124 is received by the notification control module 146 as an interaction trigger, such as a user selection or input of the notification to activate the associated device application 126 and display the viewable content associated with the notification. In the case of the foldable device 114, a user of the device may initiate the trigger input as a flip-open gesture of the foldable device from the closed configuration 140 to the open configuration 138 of the device.

At 406, one or more conditions are received from the device application as operating requirements to facilitate activation of the device application. For example, the notification control module 146 receives the application conditions 150 as operating requirements to facilitate activation of a device application 126 from the device application itself. The application conditions 150 can include any device configuration and/or operating condition needed to activate and run a device application 126 that is associated with a notification, such as if the device application has an audio requirement, a video output and display screen size requirement, available bandwidth, a network connection for downloading and/or streaming data, and/or any other device configuration and/or operating condition to activate and run a device application on the device.

At 408, the one or more conditions that facilitate the activation of the device application in a current configuration of the dual-screen device are determined. For example, the notification control module 146 also determines, from the received application conditions 150, the one or more application conditions that would facilitate activation of the device application 126 in a current configuration of the mobile device 102. For example, a device application 126 on the foldable device 114 may not be able to activate and run responsive to a trigger input 148 of a notification 124 if the foldable device is in the closed configuration 140, given that the user interface of the device application 126 cannot be displayed on the primary screen 134 that is folded and concealed from view inside of the device. Notably, the notification control module 146 can determine that an application condition 150 needed to activate the device application 126 responsive to the notification 124 being triggered has not been met (i.e., the foldable device 114 is in the closed configuration 138).

At 410, the one or more conditions to facilitate the activation of the device application are monitored over a time duration. For example, the notification control module 146 monitors the application conditions 150 for a particular device application 126 over a time duration to determine whether the application conditions change to facilitate activation of the device application responsive to a trigger input 148 of the notification 124 that is associated with the device application. The notification control module 146 monitors the application conditions 150 for the particular device application 126 over the time duration before either maintaining the notification for subsequent display or dismissing the notification.

At 412, a determination is made as to whether the one or more conditions are determined to facilitate the activation of the device application in the current configuration of the dual-screen device. For example, the notification control module 146 determines whether the application conditions 150 would facilitate activation of the device application 126 in a current configuration of the mobile device 102. If the one or more application conditions 150 are determined to facilitate the activation of the device application 126 (i.e., “Yes” from 412), then at 414, the notification is dismissed if the application conditions are conducive to facilitate the activation of the device application responsive to the trigger input of the notification. For example, the notification control module 146 dismisses the notification 124 if the device application 126 can be activated on the device and a user interface 142 of the device application is displayed on the primary screen 134, such as to display the viewable content associated with the notification in the user interface of the foldable device 114 in the open configuration 138.

If the application conditions are determined not to facilitate the activation of the device application (i.e., “No” from 412), then at 416, the notification is maintained for subsequent display if the application conditions are not conducive to facilitate the activation of the device application responsive to the trigger input of the notification. For example, the notification control module 146 maintains the notification (e.g., maintained notification 152) as a persisted notification for subsequent display if one or more of the application conditions 150 are not conducive to facilitate the activation of the device application 126 responsive to the trigger input 148 of the notification.

At 418, a display message is generated to indicate the one or more conditions are not conducive to facilitate the activation of the device application. For example, if the application conditions 150 are not met to facilitate the activation of a device application 126, the notification control module 146 generates a display message 154 to indicate that one or more of the application conditions 150 have not been met, and are not conducive to facilitate the activation of the device application. The display message 154 can be displayed for viewing on one or either of the secondary screen 116 or the primary screen 120 of the mobile phone 112. Similarly, the display message 154 can be displayed for viewing on one or either of the secondary screen 130 or the primary screen 134 of the foldable device 114. Notably, a user of the foldable device 114 is more likely to see the display message 154 displayed on the secondary screen 130 that is viewable in the closed configuration 140 of the device, or likely to see the display message 154 displayed on the primary screen 134 that is viewable in the open configuration 138 of the device.

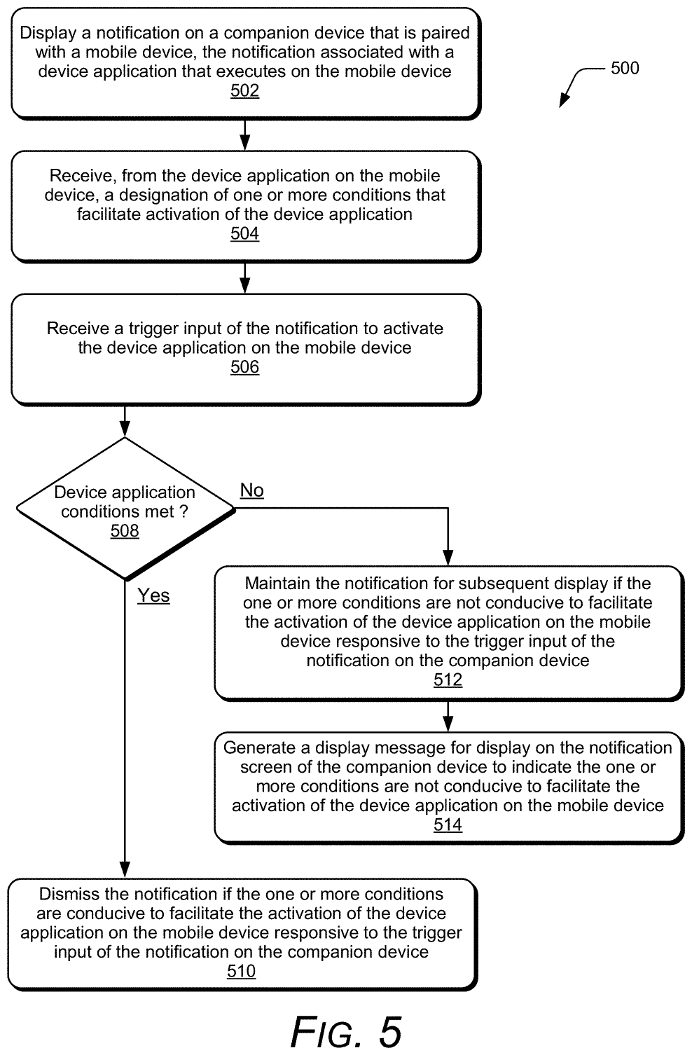

FIG. 5 illustrates example method(s) 500 of conditional device application activation responsive to a notification trigger, and is generally described with reference to a notification control module implemented in a multi-screen system. The order in which the method is described is not intended to be construed as a limitation, and any number or combination of the described method operations can be performed in any order to perform a method, or an alternate method.

At 502, a notification is displayed on a companion device that is paired with a mobile device, the notification associated with a device application that executes on the mobile device. For example, the companion device 204 as shown and described with reference to FIG. 2 can be paired with a mobile device, such as the mobile phone 202 and/or with the display device 206. The companion device 204 has the notification screen 216 to display the notification 218 that is associated with a device application 126, which executes on any of the other devices in the multi-screen system 200, such as the mobile phone 202 and/or the display device 206. Generally, the companion device 204 receives a notification 218 that displays for viewing on the notification screen 216, such as a notification of an incoming phone call, a notification of having received a text message or a new email message, or a notification of a new video as suggested viewing for the user of the device. The mobile phone 202 has a display screen 208 to display a user interface 210 of a device application 126 responsive to activation of the notification 218 on the companion device. Similarly, the display device 206 has a device screen 212 to display a user interface 214 of a device application 126 responsive to activation of the notification 218 on the companion device.

At 504, a designation of one or more conditions that facilitate activation of the device application are received from the device application on the mobile device. For example, the notification control module 228 implemented by the companion device 204 receives one or more of the application conditions 232 as operating requirements to facilitate activation of the device application 126 from the device application on the mobile phone 202 itself. The application conditions 232 can include any device configuration and/or operating condition needed to activate and run a device application that is associated with a notification 218, such as if the device application has an audio requirement, a video output and display screen size requirement, available bandwidth, a network connection for downloading and/or streaming data, and/or any other device configuration and/or operating condition to activate and run a device application on one of the paired devices.

At 506, a trigger input of the notification is received to activate the device application on the mobile device. For example, the notification control module 228 implemented by the companion device 204 receives a trigger input 230 of the notification 218 to activate a device application 126 that is associated with the notification and executable on a paired device, such as on the mobile phone 202 and/or on the display device 206. The trigger input 230 of the notification 218 can be received by the notification control module 228 as an interaction trigger, such as a user selection or input of the notification to activate the device application on the paired device and display the viewable content associated with the notification. As described above, a user of the companion device 204 may select the notification 218, such as with a touch input or some other type of trigger input to activate a device application on a paired device that is associated with the notification displayed on the companion device.

At 508, a determination is made as to whether the one or more conditions are determined to facilitate the activation of the device application on the mobile device. For example, the notification control module 228 is also implemented to determine the application conditions 232 that would facilitate activation of the device application 126 on a paired device, such as on the mobile phone 202 and/or on the display device 206. The notification control module 228 can also determine, from the received application conditions 232 (e.g., received at 504) the device configuration of the paired device and/or the one or more application conditions that would facilitate activation of the device application 126 in a current configuration of the paired device. In an environment such as the multi-screen system 200, in which the companion device 204 may be paired with more than one of the other devices in the system, the notification control module 228 can utilize the application conditions 232 to determine which of the paired devices may be best suited and/or in a configuration to display the viewable content associated with a notification 218 that is received at the companion device.

If the one or more application conditions are determined to facilitate the activation of the device application on the mobile device (i.e., “Yes” from 508), then at 510, the notification is dismissed if the one or more conditions are conducive to facilitate the activation of the device application on the mobile device responsive to the trigger input of the notification on the companion device. For example, the notification control module 228 dismisses the notification 218 if the device application 126 can be activated on the paired device and a user interface 142 of the device application is displayed on a display screen of the paired device, such as to display the viewable content associated with the notification 218 in the user interface 210 of the mobile phone 202.

If the one or more application conditions are not determined to facilitate the activation of the device application on the mobile device (i.e., “No” from 508), then at 512, the notification is maintained for subsequent display if the application conditions are not conducive to facilitate the activation of the device application on the mobile device responsive to the trigger input of the notification on the companion device. For example, the notification control module 228 maintains the notification (e.g., as the maintained notification 234) as a persisted notification for subsequent display if one or more of the application conditions 232 are not conducive to facilitate the activation of the device application 126 responsive to the trigger input 230 of the notification. The notification control module 228 maintains the notification 218 as a persisted notification for subsequent display on one or either of the notification screen 216 of the companion device 204 or the display screen 208 of the mobile phone 202.

At 514, a display message is generated for display on the notification screen of the companion device to indicate the one or more conditions are not conducive to facilitate the activation of the device application on the mobile device. For example, if the application conditions 232 are not met to facilitate the activation of a device application 126 on a paired device to the companion device 204, the notification control module 228 is implemented to generate the display message 236 to indicate that one or more of the application conditions 232 have not been met, and are not conducive to facilitate the activation of the device application 126 on the paired device (e.g., on the mobile phone 202). For example, the display message 236 can be displayed for viewing on the notification screen 216 of the companion device 204. Alternatively or in addition, the display message 236 may be displayed for viewing on the display screen 208 of the mobile phone 202, or on any of the other devices in the multi-screen system 200.

FIG. 6 illustrates various components of an example device 600, in which aspects of conditional device application activation responsive to a notification trigger can be implemented. The example device 600 can be implemented as any of the devices described with reference to the previous FIGS. 1-5, such as any type of a mobile device, mobile phone, flip phone, client device, companion device, paired device, display device, tablet, computing, communication, entertainment, gaming, media playback, and/or any other type of computing and/or electronic device. For example, the mobile device 102, the mobile phone 112, and the foldable device 114 described with reference to FIG. 1 may be implemented as the example device 600. Similarly, the mobile phone 202, the companion device 204, and the display device 206 described with reference to FIG. 2 may be implemented as the example device 600.

The device 600 includes communication transceivers 602 that enable wired and/or wireless communication of device data 604 with other devices. The device data 604 can include any of the various devices and notification control module generated, stored, and/or determined data. Additionally, the device data 604 can include any type of audio, video, and/or image data. Example communication transceivers 602 include wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.16 (WiMAX™) standards, and wired local area network (LAN) Ethernet transceivers for network data communication.

The device 600 may also include one or more data input ports 606 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 600 includes a processor system 608 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 610. The device 600 may further include any type of a system bus or other data and command transfer system that couples the various components within the device. A system bus can include any one or combination of different bus structures and architectures, as well as control and data lines.

The device 600 also includes computer-readable storage memory 612 (e.g., memory devices) that enable data storage, such as data storage devices that can be accessed by a computing device, and that provide persistent storage of data and executable instructions (e.g., software applications, programs, functions, and the like). Examples of the computer-readable storage memory 612 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 600 may also include a mass storage media device.

The computer-readable storage memory 612 provides data storage mechanisms to store the device data 604, other types of information and/or data, and various device applications 614 (e.g., software applications). For example, an operating system 616 can be maintained as software instructions with a memory device and executed by the processor system 608. The device applications may also include a device manager 618, such as any form of a control application, software application, signal-processing and control module, code that is native to a particular device, a hardware abstraction layer for a particular device, and so on.

In this example, the device 600 includes a notification control module 620 that implements aspects of conditional device application activation responsive to a notification trigger. The notification control module 620 may be implemented with hardware components and/or in software as one of the device applications 614, such as when the device 600 is implemented as the mobile device 102 described with reference to FIG. 1 or as the companion device 204 described with reference to FIG. 2. Examples of the notification control module 620 includes the notification control module 146 that is implemented by the mobile device 102 and the notification control module 228 that is implemented by the companion device 204, such as a software application and/or as hardware components in the mobile device and/or in the companion device. In implementations, the notification control module 620 may include independent processing, memory, and logic components as a computing and/or electronic device integrated with the example device 600.

In this example, the device 600 also includes a camera 622 and motion sensors 624, such as may be implemented as components of an inertial measurement unit (IMU). The motion sensors 624 can be implemented with various sensors, such as a gyroscope, an accelerometer, and/or other types of motion sensors to sense motion of the device. The motion sensors 624 can generate sensor data vectors having three-dimensional parameters (e.g., rotational vectors in x, y, and z-axis coordinates) indicating location, position, acceleration, rotational speed, and/or orientation of the device. The device 600 can also include one or more power sources 626, such as when the device is implemented as a mobile device or collaborative device. The power sources may include a charging and/or power system, and can be implemented as a flexible strip battery, a rechargeable battery, a charged super-capacitor, and/or any other type of active or passive power source.

The device 600 can also include an audio and/or video processing system 628 that generates audio data for an audio system 630 and/or generates display data for a display system 632. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 634. In implementations, the audio system and/or the display system are integrated components of the example device. Alternatively, the audio system and/or the display system are external, peripheral components to the example device.

Although implementations of conditional device application activation responsive to a notification trigger have been described in language specific to features and/or methods, the subject of the appended claims is not necessarily limited to the specific features or methods described. Rather, the specific features and methods are disclosed as example implementations of conditional device application activation responsive to a notification trigger, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

A dual-screen device, comprising: a secondary screen to display a notification associated with a device application; a primary screen to display a user interface of the device application responsive to activation of the notification; a notification control module implemented at least partially in hardware to: receive a trigger input of the notification to activate the device application; determine one or more conditions that facilitate activation of the device application in a current configuration of the dual-screen device; and maintain the notification for subsequent display if the one or more conditions are not conducive to facilitate the activation of the device application responsive to the trigger input of the notification.

Alternatively or in addition to the above described dual-screen device, any one or combination of: the notification control module is implemented to dismiss the notification if the one or more conditions are conducive to facilitate the activation of the device application responsive to the trigger input of the notification. The notification control module is implemented to dismiss the notification if the one or more conditions are conducive to facilitate the activation of the device application and the user interface of the device application is displayed on the primary screen. The notification control module is implemented to monitor the one or more conditions to facilitate activation of the device application over a time duration before one of the notification is maintained for subsequent display or the notification is dismissed. The trigger input of the notification is an interaction trigger of the notification to activate the device application and display viewable content associated with the notification. The device application designates the one or more conditions to facilitate the activation of the device application, and the notification control module is implemented to receive the one or more conditions as operating requirements from the device application. The dual-screen device includes the secondary screen to display the notification on a first side of the dual-screen device, and includes the primary screen to display the user interface of the device application on a second side of the dual-screen device. The dual-screen device is a foldable device with the secondary screen being viewable and the primary screen being concealed from view in a closed configuration of the foldable device. The dual-screen device is a flip phone with the secondary screen being viewable and the primary screen being concealed from view in a closed configuration of the flip phone; and the notification control module is implemented to receive the trigger input of the notification as a flip-open gesture of the flip phone from the closed configuration to an open configuration of the flip phone. The notification control module is implemented to maintain the notification as a persisted notification for the subsequent display on the secondary screen of the dual-screen device. The notification control module is implemented to generate a display message to indicate the one or more conditions are not conducive to facilitate the activation of the device application.

A multi-screen system, comprising: a mobile device with a device screen to display a user interface of a device application responsive to activation of a notification; a companion device paired with the mobile device, the companion device having a notification screen to display the notification associated with the device application that executes on the mobile device; a notification control module implemented by the companion device to: receive, from the device application on the mobile device, a designation of one or more conditions that facilitate activation of the device application; receive a trigger input of the notification to activate the device application on the mobile device; and maintain the notification for subsequent display if the one or more conditions are not conducive to facilitate the activation of the device application on the mobile device responsive to the trigger input of the notification on the companion device.

Alternatively or in addition to the above described multi-screen system, any one or combination of: the notification control module is implemented to dismiss the notification if the one or more conditions are conducive to facilitate the activation of the device application on the mobile device responsive to the trigger input of the notification on the companion device. The trigger input of the notification is an interaction trigger of the notification received at the companion device to activate the device application on the mobile device and display viewable content associated with the notification. The notification control module is implemented to maintain the notification as a persisted notification for the subsequent display on one of the notification screen of the companion device or the device screen of the mobile device. The notification control module is implemented to generate a display message for display on the notification screen of the companion device to indicate the one or more conditions are not conducive to facilitate the activation of the device application on the mobile device.

A method, comprising: displaying a notification associated with a device application on a secondary screen of a dual-screen device; receiving a trigger input of the notification to activate the device application and display viewable content associated with the notification on a primary screen of the dual-screen device; determining one or more conditions that facilitate activation of the device application in a current configuration of the dual-screen device; and maintaining the notification for subsequent display if the one or more conditions are not conducive to facilitate the activation of the device application responsive to the trigger input of the notification.

Alternatively or in addition to the above described method, any one or combination of: dismissing the notification if the one or more conditions are conducive to facilitate the activation of the device application responsive to the trigger input of the notification. The method further comprising monitoring the one or more conditions to facilitate the activation of the device application over a time duration before one of the maintaining the notification for subsequent display or the dismissing the notification. The method further comprising receiving, from the device application, the one or more conditions as operating requirements to facilitate the activation of the device application.

1. A dual-screen device, comprising:
a secondary screen to display a notification associated with a device application;
a primary screen to display a user interface of the device application responsive to activation of the notification;
a notification control module implemented at least partially in hardware to:
receive a trigger input of the notification to activate the device application;
determine one or more conditions that facilitate activation of the device application in a current configuration of the dual-screen device; and
maintain the notification for subsequent display if the one or more conditions are not conducive to facilitate the activation of the device application responsive to the trigger input of the notification.

2. The dual-screen device as recited in claim 1, wherein the notification control module is implemented to dismiss the notification if the one or more conditions are conducive to facilitate the activation of the device application responsive to the trigger input of the notification.

3. The dual-screen device as recited in claim 1, wherein the notification control module is implemented to dismiss the notification if the one or more conditions are conducive to facilitate the activation of the device application and the user interface of the device application is displayed on the primary screen.

4. The dual-screen device as recited in claim 3, wherein the notification control module is implemented to monitor the one or more conditions to facilitate activation of the device application over a time duration before one of the notification is maintained for subsequent display or the notification is dismissed.

5. The dual-screen device as recited in claim 1, wherein the trigger input of the notification is an interaction trigger of the notification to activate the device application and display viewable content associated with the notification.

6. The dual-screen device as recited in claim 1, wherein the device application designates the one or more conditions to facilitate the activation of the device application, and the notification control module is implemented to receive the one or more conditions as operating requirements from the device application.

7. The dual-screen device as recited in claim 1, wherein the dual-screen device includes the secondary screen to display the notification on a first side of the dual-screen device, and includes the primary screen to display the user interface of the device application on a second side of the dual-screen device.

8. The dual-screen device as recited in claim 1, wherein the dual-screen device is a foldable device with the secondary screen being viewable and the primary screen being concealed from view in a closed configuration of the foldable device.

9. The dual-screen device as recited in claim 1, wherein:
the dual-screen device is a flip phone with the secondary screen being viewable and the primary screen being concealed from view in a closed configuration of the flip phone; and
the notification control module is implemented to receive the trigger input of the notification as a flip-open gesture of the flip phone from the closed configuration to an open configuration of the flip phone.

10. The dual-screen device as recited in claim 1, wherein the notification control module is implemented to maintain the notification as a persisted notification for the subsequent display on the secondary screen of the dual-screen device.

11. The dual-screen device as recited in claim 1, wherein the notification control module is implemented to generate a display message to indicate the one or more conditions are not conducive to facilitate the activation of the device application.

12. A multi-screen system, comprising:
a mobile device with a device screen to display a user interface of a device application responsive to activation of a notification;
a companion device paired with the mobile device, the companion device having a notification screen to display the notification associated with the device application that executes on the mobile device;
a notification control module implemented by the companion device to:
receive, from the device application on the mobile device, a designation of one or more conditions that facilitate activation of the device application;
receive a trigger input of the notification to activate the device application on the mobile device; and
maintain the notification for subsequent display if the one or more conditions are not conducive to facilitate the activation of the device application on the mobile device responsive to the trigger input of the notification on the companion device.

13. The multi-screen system as recited in claim 12, wherein the notification control module is implemented to dismiss the notification if the one or more conditions are conducive to facilitate the activation of the device application on the mobile device responsive to the trigger input of the notification on the companion device.

14. The multi-screen system as recited in claim 12, wherein the trigger input of the notification is an interaction trigger of the notification received at the companion device to activate the device application on the mobile device and display viewable content associated with the notification.

15. The multi-screen system as recited in claim 12, wherein the notification control module is implemented to maintain the notification as a persisted notification for the subsequent display on one of the notification screen of the companion device or the device screen of the mobile device.

16. The multi-screen system as recited in claim 12, wherein the notification control module is implemented to generate a display message for display on the notification screen of the companion device to indicate the one or more conditions are not conducive to facilitate the activation of the device application on the mobile device.

17. A method, comprising:
displaying a notification associated with a device application on a secondary screen of a dual-screen device;
receiving a trigger input of the notification to activate the device application and display viewable content associated with the notification on a primary screen of the dual-screen device;
determining one or more conditions that facilitate activation of the device application in a current configuration of the dual-screen device; and
maintaining the notification for subsequent display if the one or more conditions are not conducive to facilitate the activation of the device application responsive to the trigger input of the notification.

18. The method as recited in claim 17, further comprising:
dismissing the notification if the one or more conditions are conducive to facilitate the activation of the device application responsive to the trigger input of the notification.

19. The method as recited in claim 18, further comprising:
monitoring the one or more conditions to facilitate the activation of the device application over a time duration before one of the maintaining the notification for subsequent display or the dismissing the notification.

20. The method as recited in claim 17, further comprising:
receiving, from the device application, the one or more conditions as operating requirements to facilitate the activation of the device application.
